(19) United States
(12) Patent Application Publication
(10) Pub. No.: US 2018/0060820 A1
(43) Pub. Date: Mar. 1, 2018

(54) Career Exploration and Employment Search Tools Using Dynamic Node Network Visualization

(71) Applicant: Capstone Technology Resources, Inc., Sausalito, CA (US)

(72) Inventors: Cynthia Reuter, San Francisco, CA (US); James Collier, San Anselmo, CA (US); Michael Nakahara, Larkspur, CA (US)

(73) Assignee: Capstone Technology Resources, Inc.

(21) Appl. No.: 15/247,731

(22) Filed: Aug. 25, 2016

(51) Int. Cl. G06Q 10/10; G06Q 10/06

(52) U.S. Cl. CPC G06Q 10/1053; G06Q 10/067

(57) ABSTRACT

Apparatuses and computer-implemented methods are presented for discovering career and job opportunities that are categorized within one or more taxonomies having hierarchical categories. A taxonomy selection mechanism may be provided to enable user selection of one of multiple taxonomies for navigation. A taxonomic node network is rendered on a first portion of a user computing device display screen. The taxonomic node network includes elements corresponding to categories within the selected taxonomy, with the elements being animated for dynamic redistribution around a selected one of the network elements. Another portion of the user computing device display screen is automatically updated to display indicia of job opportunities categorized within a taxonomy category associated with the selected network element.

### TECHNICAL FIELD

The present disclosure relates in general to online career exploration and job searching, and in particular to platforms, tools and methods with which users can interactively explore, discover, understand, apply, and share career interests and job opportunities.

### BACKGROUND

Individuals increasingly rely on online job sites and other web-based platforms for purposes of learning about careers, and applying for job opportunities. However, career and job searches using conventional job boards typically require pre-existing knowledge concerning the nature of the job or career desired. For example, users may have to manually type in relevant keywords to filter available jobs. Alternatively, users may be requested to select search criteria from massive, hierarchical pick lists that may include significant amounts of field-specific jargon and obscure terminology.

While experts or veteran workers in a given field may have sufficient industry expertise to navigate such sites and identify desired types of jobs, opportunities in different but related fields may easily remain undiscovered due to, e.g., unfamiliarity with field-specific terminology or unawareness of skill set overlap. The problem is even worse for individuals lacking deep expertise in any existing industry or work environment, such as for students seeking internships, deciding on a course of study or seeking a first job after graduation, parents trying to assist their children in selecting a career, or educators and counselors assisting students in the selection of a degree. Lack of familiarity with industry jargon, job titles, types of new careers, practices and skill set applicability may greatly limit a searcher's ability to identify opportunities that are most of interest and best matched to the searcher's interests and skills.

### SUMMARY

Apparatuses and computer-implemented methods are presented for discovering career and job opportunities that are categorized within one or more taxonomies having hierarchical categories. Taxonomies may include, e.g., industry, career type, product or service, global issues, interests, degree, location, education level and/or company. One of multiple taxonomies can be selected, e.g. via a mechanism such as radio buttons or a modal selection mechanism. A selected hierarchical taxonomy is rendered via an animated node network, with network nodes representing taxonomy categories. Variable stylization may be applied to the node elements, e.g. varying apparent transparency, color, font or other characteristics based on node distance from the currently-selected node element. Users may select any of the node network elements, with other elements animated for reorientation around the selected element. Another portion of the display is automatically updated to display indicia of career and job opportunities categorized within a taxonomy category associated with the selected network element. Career and job opportunity indicia may be selected to display details concerning the selected career or job opportunity.

In accordance with another aspect of the disclosure, apparatuses and computer-implemented methods may utilize an interactive node network display to facilitate discovery and selection of elements from within a hierarchical taxonomy, such as for population of form fields. Elements selected from the animated node network may be utilized to populate one or more form fields, such as while constructing a multi-field career or job search query or while creating a new career or job opportunity record.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic block diagram of a computing environment that may be used in some embodiments.

FIG. 2 is a schematic block diagram of application logic.

FIG. 3 is a process diagram of a process for discovering career and job opportunities using a selected taxonomy.

FIG. 4A is a schematic diagram of an exemplary taxonomy.

FIG. 4B is an exemplary job opportunity record.

FIG. 5A is a node network user interface for displaying career and job opportunities on a computing device.

FIG. 5B is a computing device user interface with modal taxonomy selection component.

FIG. 6 is a job detail view for display on a computing device.

FIG. 7 is a node network user interface for displaying career and job opportunities on a computing device.

FIG. 8 is a node network user interface for displaying career and job opportunities on a computing device.

FIG. 9 is a node network user interface for displaying career and job opportunities on a computing device.

FIG. 10 is a node network user interface for displaying career and job opportunities on a computing device.

FIG. 11 is a node network user interface for displaying career and job opportunities on a computing device.

FIG. 12 is a node network user interface for displaying career and job opportunities on a computing device.

FIG. 13 is a node network user interface for displaying career and job opportunities on a computing device.

FIG. 14 is a node network user interface for displaying career and job opportunities on a computing device.

FIG. 15 is a node network user interface for displaying career and job opportunities on a computing device.

FIG. 16 is a node network user interface for displaying career and job opportunities on a computing device.

FIG. 17 is a node network user interface for displaying career and job opportunities on a computing device.

FIG. 18 is a node network user interface for displaying career and job opportunities on a computing device.

FIG. 19 is a node network user interface for populating form fields on a computing device.

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

Computing Environment

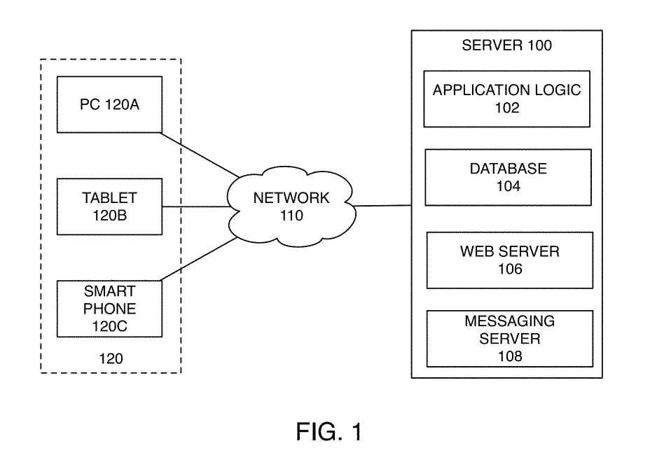

FIG. 1 is schematic block diagram of a computing environment that may be effectively utilized to implement certain embodiments of the platform and methods described herein. Server 100 communicates, inter alia, via computer network 110, which may include the Internet, with user personal electronic devices 120 such as personal computer 120A, tablet computer 120B, and smart phone 120C. While FIG. 1 illustrates three exemplary user devices, it is contemplated and understood that implementations may include large numbers of user devices. For example, some implementations may include user devices of different types for each of many individuals around the world.

Server 100 implements application logic 102, and operates to store information within, and retrieve information from, database 104. The term “database” is used herein broadly to refer to a store of data, whether structured or not, including without limitation relational databases and document databases. Web server 106 hosts one or more Internet web sites enabling outside user interaction with, amongst other things, application logic 102 and database 104. Messaging server 108 enables notifications and messaging (such as SMS, MMS, mobile app notifications and desktop push notifications), between server 100 and user devices 120.

While depicted in the schematic block diagram of FIG. 1 as a block element with specific sub-elements, as known in the art of modern web applications and network services, server 100 may be implemented in a variety of ways, including using distributed hardware and software resources and using any of multiple different software stacks. Server 100 may include a variety of physical, functional and/or logical components such as one or more each of web servers, application servers, database servers, email servers, storage servers, messaging servers, and the like. That said, implementations of server 100 will typically include at some level one or more physical servers, at least one of the physical servers having one or more microprocessors and digital memory for, inter alia, storing instructions which, when executed by the processor, cause the server to perform methods and operations described herein.

Certain embodiments described hereinbelow are described in the context of a web application implemented by server 100, communicating via network 110 with a web browser application running locally on user devices 120. Various user interfaces and user interactions described herein are implemented by rendering elements and indicia on a display screen of user device 120, and receiving input via mechanisms such as physical or soft keyboards, pointing devices and touchscreens. However, it is contemplated and understood that in other embodiments, an installed application may be used in lieu of or in addition to web applications. For example, in lieu of rendering user interfaces via a local user web browser communicating with server 100, a locally installed application may render user interfaces locally using installed software components, with variable data content being stored locally and/or accessed from server 100 via an API (application programming interface) or other network-based communication mechanism. In such locally-installed embodiments, some or all functionality otherwise performed by server application logic 102 may instead be performed locally on user device 120 via analogous application logic implemented thereon.

Career and Job Search Mechanism Using Taxonomic Node Visualization

The computing environment of FIG. 1 can be utilized to implement a tool for searching and reviewing potential employment opportunities in a manner that encourages exploration and enables effective discovery of job and career opportunities for individuals having even low levels of familiarity with a profession or industry, such as students and entry-level workers. In some embodiments, a node network-based visualization component presents interactive views of a job and career set that has been characterized according to multiple taxonomies. A student or other user can utilize the visualization component to interactively explore opportunities and identify a set of opportunities of interest, for further review, pursuit and sharing with others.

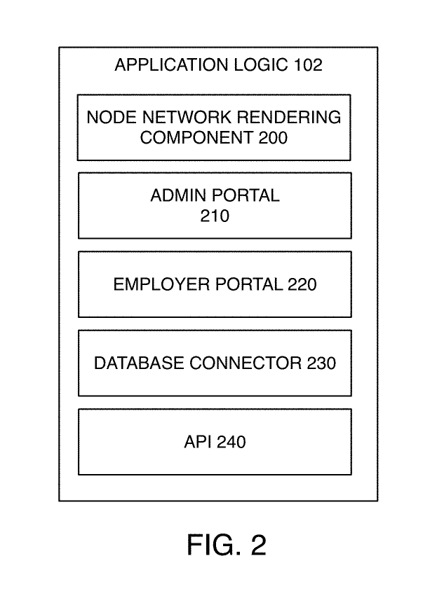

A career and job search and exploration platform can be implemented on, e.g., server 100 implementing application logic 102. Components of application logic 102 are illustrated in FIG. 2, and include: node network rendering component 200, administration portal 210, employer portal 220, database connector 230, and API 240. Each of these components are discussed further below. While components of application logic 102 are illustrated as being implemented within server 100, it is contemplated and understood that in use, aspects of application logic 102 can be temporarily downloaded to a user device 120 via network 110 for execution locally within a user device web browser application.

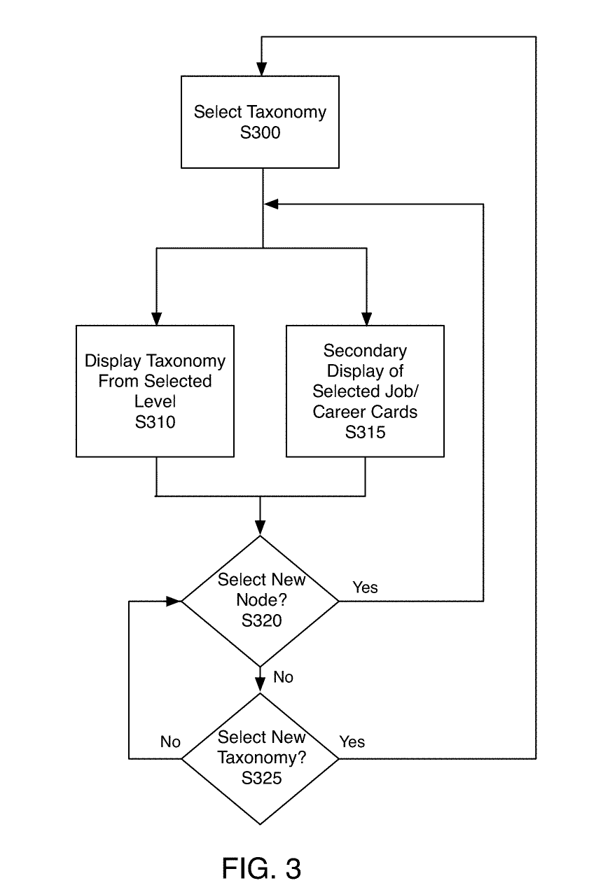

FIG. 3 illustrates a process for implementing the career or job visualization mechanism, in which a dynamic taxonomic node visualization is interactively linked with a secondary display of job opportunities. In step S300, a taxonomy is selected for use in exploring career or job opportunities. Preferably, each career and job opportunity is pre-characterized within multiple different taxonomies that may be useful to a job seeker. In some embodiments, taxonomies applicable to exploring career and job opportunities may include: Industry, Career, Product or Service, Global Issues, Interests, Degree, Location, Education Level and Companies. In other embodiments, additional, fewer and/or different taxonomies may be utilized. Each taxonomy includes one or more categories, which may be ordered hierarchically.

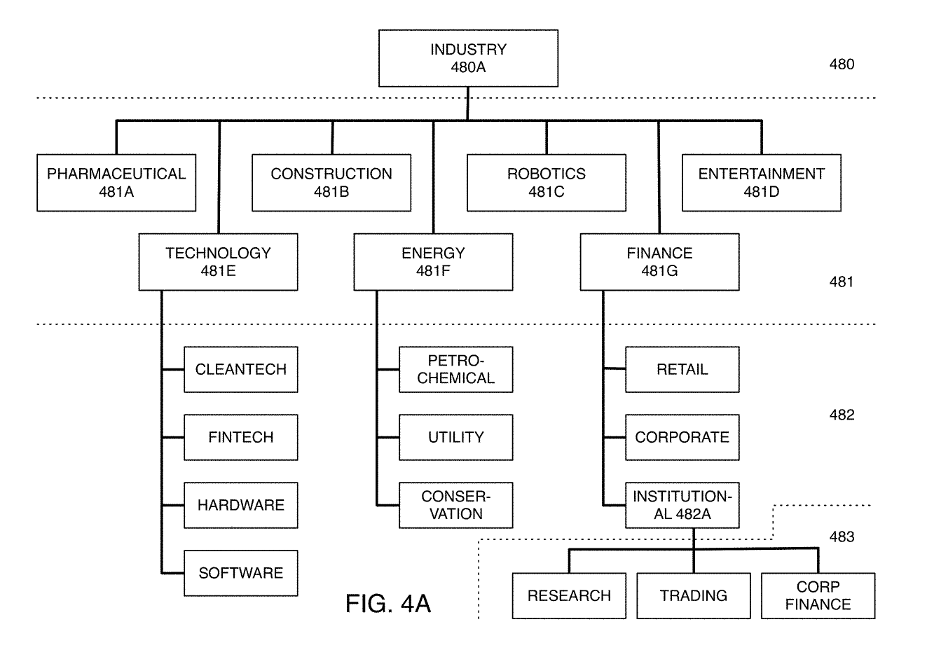

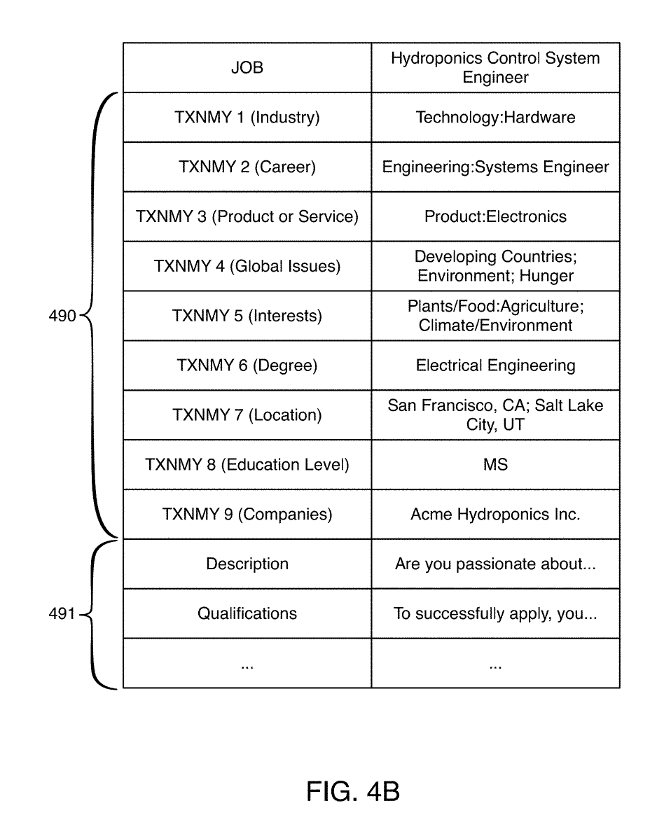

FIG. 4A illustrates examples of categories within a hierarchical Industry taxonomy. The hierarchy of FIG. 4A includes a top-level 480 having top-level node 480A (typically the name of the taxonomy). A second hierarchy level 481 (typically containing a broadest set of classifications within the taxonomy), includes in this example seven categories 481A-G. Categories 481E, 481F and 481G include subcategories within hierarchy level 482. Category 482A includes further subcategories within hierarchy level 483. In practice, various taxonomies can include varying numbers of categories across various numbers of hierarchy levels. In some embodiments, taxonomies can be user-defined and evolve during use of the platform, such that the platform can evolve to meet needs of new employers and evolving areas of technology. In some embodiments, taxonomy category definition can be managed by a central resource, such as via admin portal 210, in order to help ensure consistency and avoid duplication.

Each job and career opportunity may be associated with one or more categories within each taxonomy. In some embodiments, job and career opportunities may be characterized by the hiring employer, such as during definition of the job or career opportunity within a web-based employer portal implemented by server 100, web server 106, application logic 102 (including employer portal 220) and database 104. In other embodiments, job and career opportunities may be characterized by a recruiter or other entity maintaining the job and career search mechanism, via network-based interaction with a web-based admin portal implemented by server 100, web server 106, application logic 102 (including admin portal 210) and database 104. In either case, web server 106 may interact with user computing device 120 to render a web-based user interface through which job and career opportunities may be entered. Each job or career opportunity is stored as a record or related set of records within database 104. FIG. 4B illustrates exemplary portions of information that may be included in a job or career opportunity record, including multiple taxonomic classifications 490 and detail job/career opportunity fields 491.

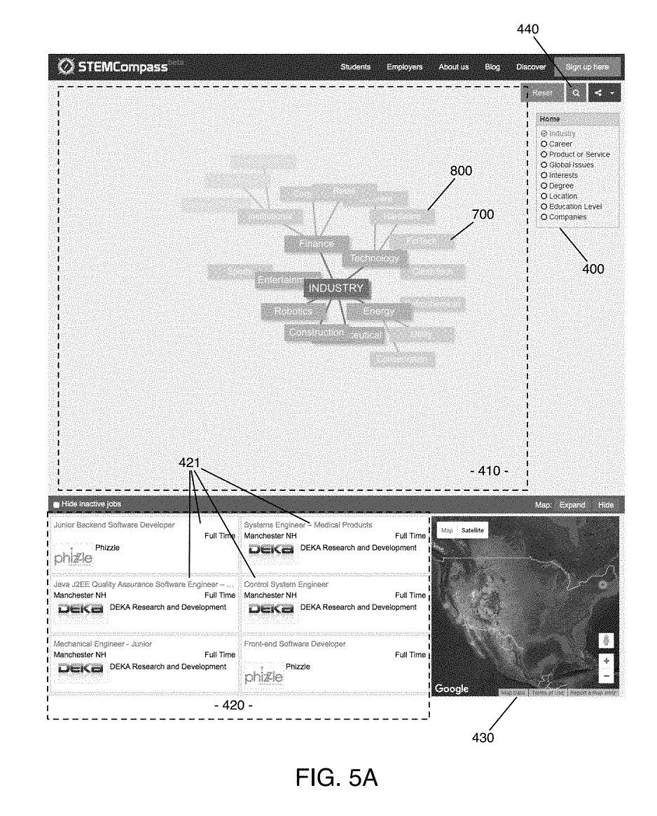

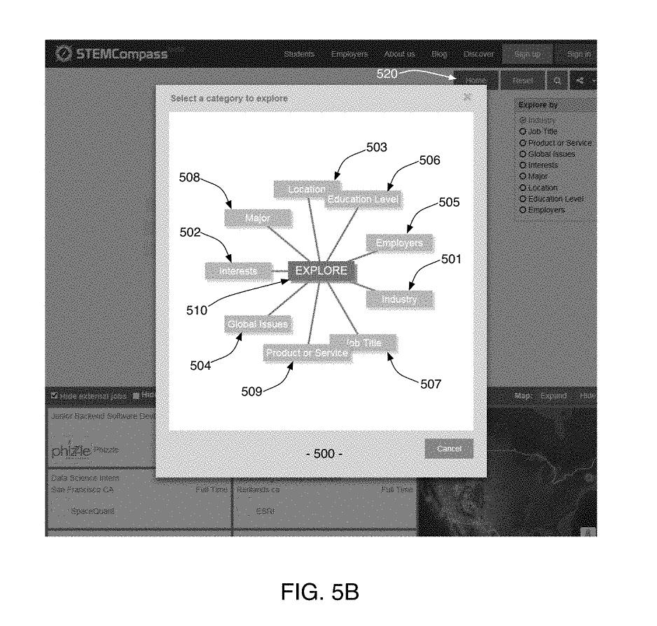

FIG. 5A illustrates an exemplary user interface that may be rendered during step S300. Pane 400 is a taxonomy selection mechanism providing, e.g., radio buttons enabling selection of one of multiple taxonomies for organizing job/career opportunities. The taxonomy selection is modifiable by the user using pane 400.

In other embodiments, a modal selection mechanism may be provided through which a user can select a desired taxonomy. FIG. 5B illustrates such an embodiment. Taxonomy selection region 500 is rendered as a modal, and includes home node 510, linked with multiple taxonomy node indicia 501-509. Any of taxonomy indicia 501-509 can be selected via, e.g., a point-and-click mouse user interface or tapping a touch-based user interface. In embodiments using the modal taxonomy selection mechanism of FIG. 5B, a HOME button 520 can be provided in or proximate taxonomy node network views (such as those of FIGS. 5A, 7, 8, et seq.), selection of which returns the display to the modal taxonomy selection mechanism of FIG. 5B for selection of a different taxonomy.

After selection of a taxonomy, two simultaneously steps occur. In step S310, a node view for the selected taxonomy is rendered based on a currently-selected node. Meanwhile, in step S315, a secondary display is rendered in which job and career opportunities associated with the currently-selected taxonomy node are displayed.

More specifically, in step S310, region 410 provides a taxonomic node visualization for the selected taxonomy rendered by node network rendering component 200. A hierarchical taxonomy is presented as a dynamic node cluster, with each taxonomy category rendered as a node. The entire cluster is generally centered around one or more currently-selected nodes. Newly-selected taxonomies typically default to a top-level node (e.g. node 480A in FIG. 4A) as the initially selected node.

Node network rendering component 200 may provide animated transitions as different nodes are selected. If the taxonomy display is transitioning due to selection of a different node in an already-selected taxonomy in step S310 (as opposed to an initial default taxonomy display), the node cluster can be animated to automatically reorganize itself to place the newly-selected node centrally within region 420. In some embodiments, node network rendering component 200 may be downloaded to a client device 120 web browser and implemented using the JavaScript InfoVis Toolkit (available at http://philogb.github.io/jit/index.html) to facilitate animation of the adaptive cluster. In some embodiments, a bounce effect may be further utilized whereby moving elements of node graph 410 are animated to temporarily overshoot their target positions when reorganized, before rebounding into final position. The bounce effect has been found to effectively narrow user focus to a selected node, particularly when dynamically navigating complex node networks.

In some embodiments, nodes may be represented by solid color blocks having a text label overlaid thereon. Typically, the label is descriptive of the taxonomy category represented by the node. Adaptive stylization may be utilized to intuitively convey degree of relation between various nodes displayed in region 410. For example, nodes may be displayed with an apparent transparency that increases based on the number of node hops each displayed node is from the selected node. E.g. a selected node may be displayed at 100% opacity (fully non-transparent); nodes one hop from the selected node may be displayed at 80% opacity; nodes two hops from the selected node may be displayed at 60% transparency; and so on. In some embodiments, adaptive stylization schemes may include threshold node distance levels or other nonlinearities; for example, transparency may vary over the first three degrees of node distance, after which transparency may be maintained at a constant level. Other stylization characteristics that may be varied based on distance from currently selected node(s) include characteristics such as: node color, node size, node shape, shadow size, shadow opacity, and label font. In some embodiments, two or more stylization characteristics may be dynamically modified based on node distance from a currently-selected node.

In some circumstances, multiple nodes may be selected simultaneously. For example, search indicia 440 may be selected to initiate a text-based search for node labels within the currently-displayed taxonomy. In the example of FIG. 5A, displaying Industry taxonomy, a user may search for “en”, in which case region 410 adapts to highlight both “Entertainment” and “Energy” as selected nodes, such that both are displayed with 100% opacity. Other nodes can then be displayed with an opacity level based on each node's minimum distance from any of the currently-selected nodes.

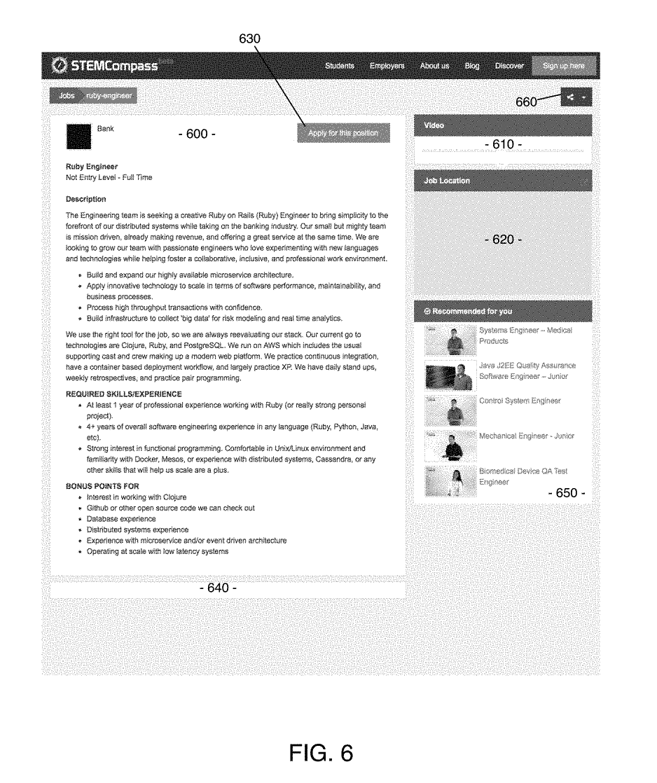

Returning to the process of FIG. 3, in step S315, region 420 provides a scrollable pane with card-views of job and career opportunities that are responsive to (1) the taxonomy category associated with the node currently selected in region 410, or (2) any category hierarchically beneath the category associated with the selected node. A short summary of each responsive job and career opportunity is presented on each card 421. Any of cards 421 can be selected to transition the displayed user interface to a detailed job/career view for closer examination. FIG. 6 illustrates an exemplary detailed job/career view. Pane 600 presents a detailed description of the job opportunity and required qualifications. Pane 610 provides for viewing of video content associated with the job and career opportunity, such as a company employee having a similar job discussing their work. Pane 620 may display the job and career location in a map view. If a user desires to pursue the displayed job or career, Apply button 630 can be selected to directly initiate a job application process. Pane 640 can be used to display short tags associated with the job or career opportunity detailed in pane 600. Pane 650 provides links to other job or career opportunities that are similar or in some way related to the job or career opportunity displayed in pane 600, such that a viewer interested in an opportunity displayed in pane 600 may also wish to consider opportunities displayed in pane 640. In some embodiments, selection of opportunities for display in pane 650 can be implemented by identifying opportunities sharing common tags, keywords, taxonomic classifications and/or detailed description verbiage. Sharing indicia 660 can be selected to send information concerning the job or career opportunity of pane 600 to others via, e.g., email, SMS, or social networking platforms.

The exemplary user interface of FIG. 5A also includes region 430, providing a geographic mapping of job and career opportunities displayed in region 420, to the extent that database records associated with each such opportunity is geo-coded with one or more job and career locations.

Within node network region 410, any node can be selected directly by a user, although in some embodiments, stylization effects such as those described above may focus the user's attention on nodes closest to the currently selected node, thereby encouraging an orderly and progressive exploration of the node network. In step S320, a determination is made as to whether a new node within region 410 has been selected by a user, such as via clicking a node element using a pointer device and associated user interface, or tapping a node element with a touch-based UI. If so, the process returns to steps S310 and S315 to reorganize the node network within region 410 and automatically update secondary display 420 to display cards for job and career opportunities associated with the taxonomy category of the newly-selected node. If no new node is selected, a determination can be made as to whether a new taxonomy is selected in region 400. If so, the process repeats with transition to initial display of the newly-selected taxonomy (e.g. to step S300).

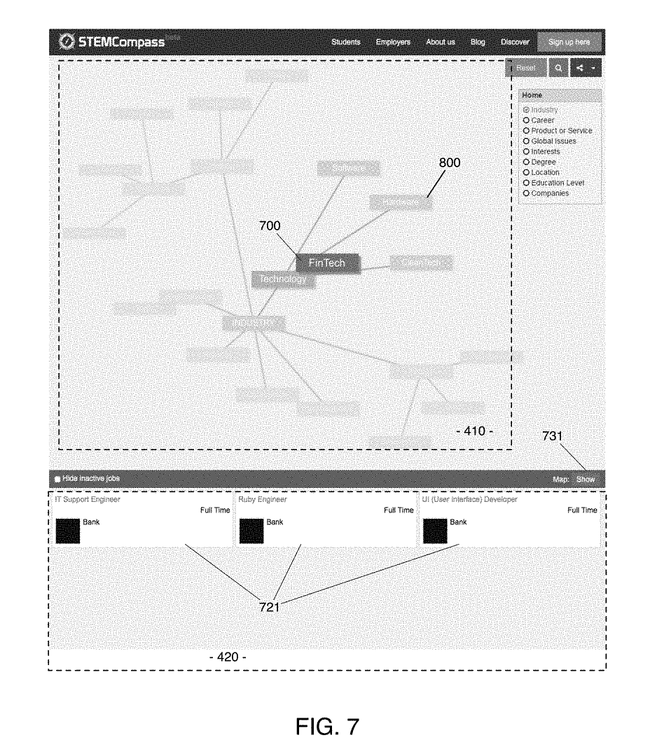

FIG. 7 illustrates a user interface view rendering the node network of FIG. 5A after a FinTech industry node indicia 700 has been selected by a user. The node network in region 410 is animated to reorganize itself in step S310, such that selected node 700 is positioned generally centrally within region 410, with each node indicia assigned updated color and stylization based on its distance from selected node 700. Secondary display pane 420 is updated (step S315) to display summary card views 721 for job opportunities associated with the selected “FinTech” industry taxonomic classification. In the view of FIG. 7, the map-based view analogous to pane 430 has been hidden; it can be reinstated via selection of indicia 731.

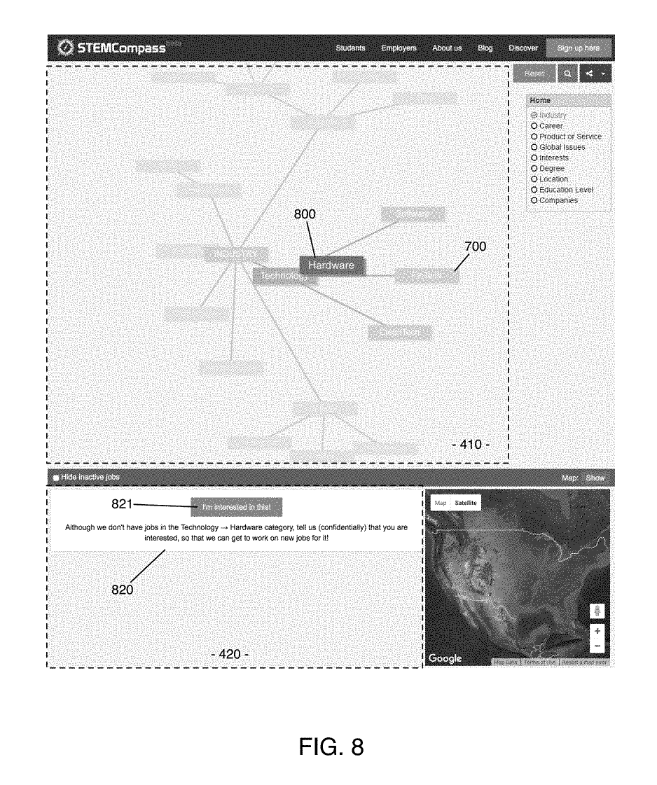

FIG. 8 illustrates a user interface view rendering the Industry node network of FIG. 4, after a Hardware industry indicia 800 has been selected by a user. The node network in region 410 is animated to reorganize itself in step S310, such that selected node 800 is positioned generally centrally within region 410, with each node assigned updated color and stylization based on its distance from selected node 800. In the illustrated embodiment, no job or career opportunities are associated with the selected “Hardware” node 800; thus, secondary display pane 420 is updated (step S315) to display no summary card views for job or career opportunities. Rather, interest indication card 820 may be displayed, which includes button indicia 821 which can be selected by a user to indicate interest in job and career opportunities associated with the selected taxonomic category.

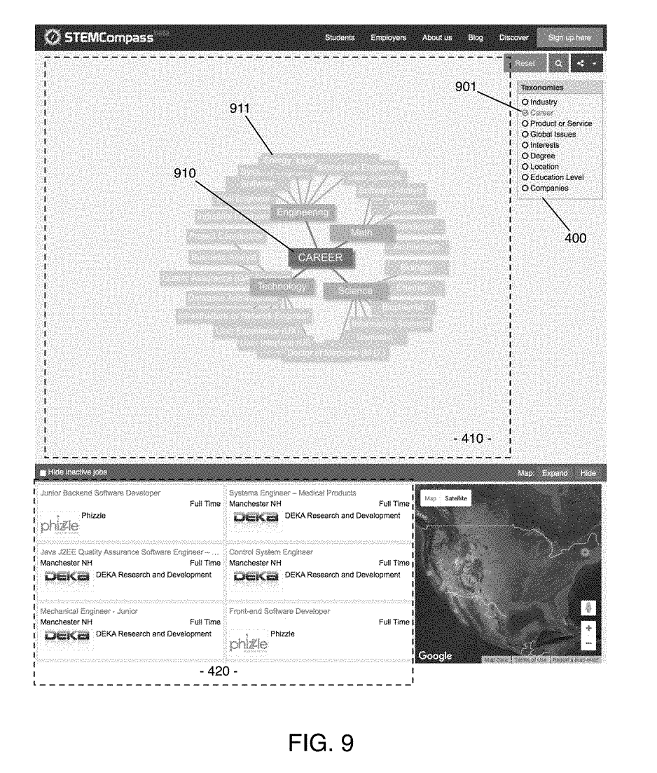

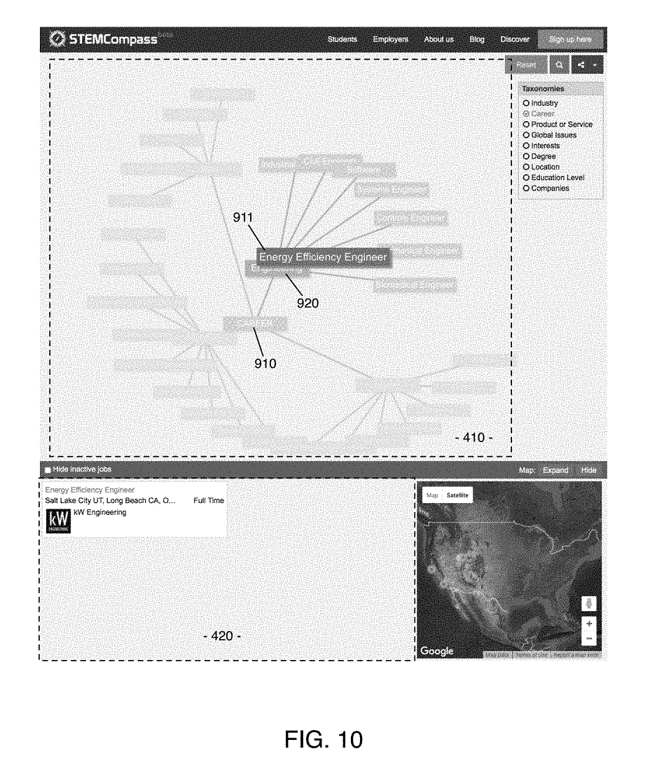

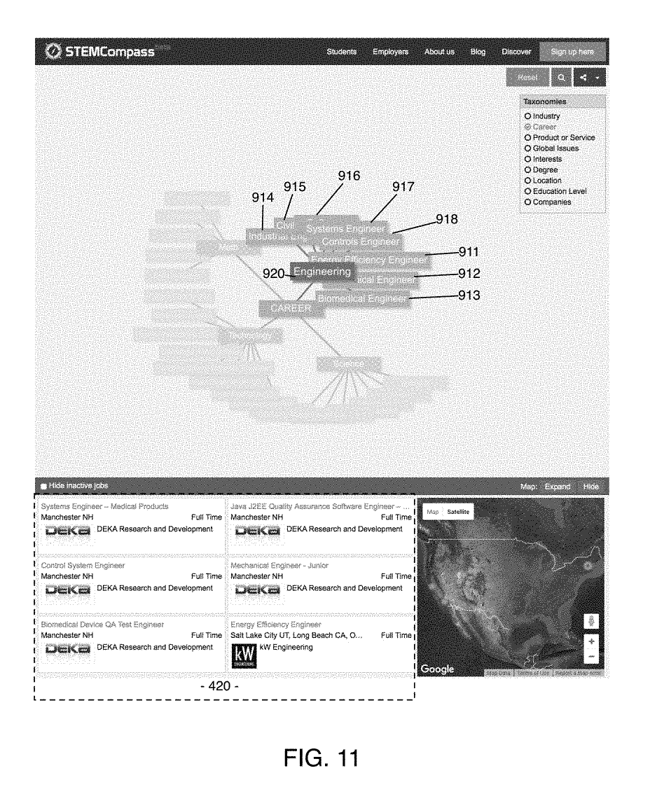

FIG. 9 illustrates a user interface view after a new taxonomy is selected in step S325. In the embodiment of FIG. 9, Career radio button 901 has been selected within taxonomy selection pane 400. Node network view display region 410 is updated to illustrate a node cluster of Career taxonomy categories, with a default top level node 910 displayed centrally, and associated nodes arranged around node 910. Color and other stylization attributes are applied to nodes within region 410 based on their distance from top level node 910. Job/career opportunity cards associated with the career top level category 910 (or any categories hierarchically beneath it within the Career taxonomy) are rendered within secondary pane 420. FIG. 10 illustrates the arrangement of FIG. 9, after selection of node 911 within region 410. Region 420 is updated to display only job/career opportunity preview cards associated with the taxonomic category associated with selected node 911. FIG. 11 illustrates the arrangement of FIG. 9, after selection of upstream node 920 within region 410. Region 420 is updated to display only job/career opportunity preview cards associated with the taxonomic category of selected node 920, or hierarchically-lower categories associated with nodes 911-918.

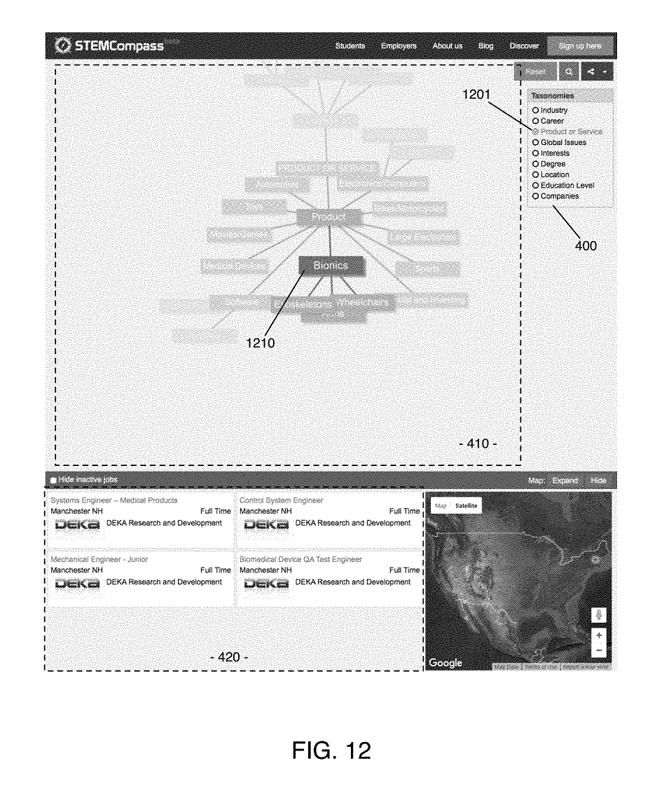

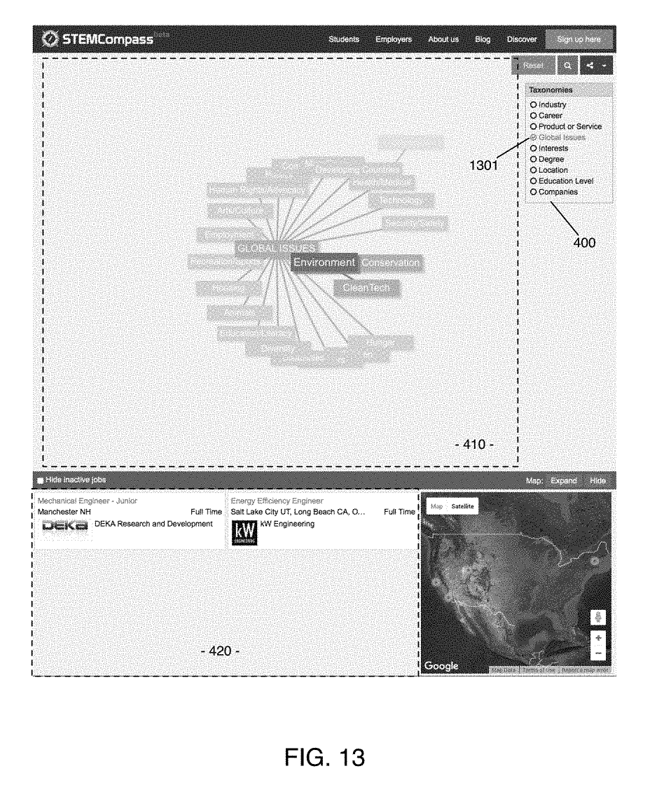

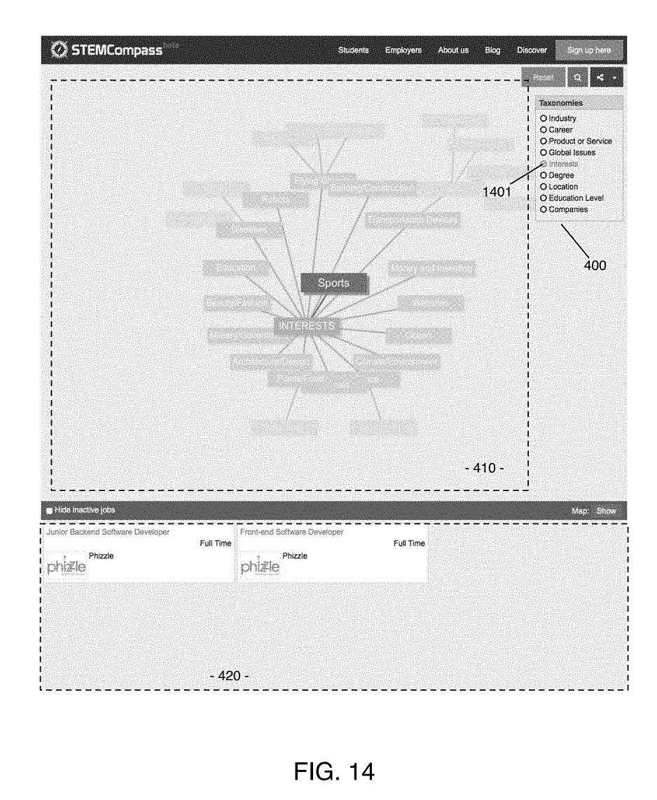

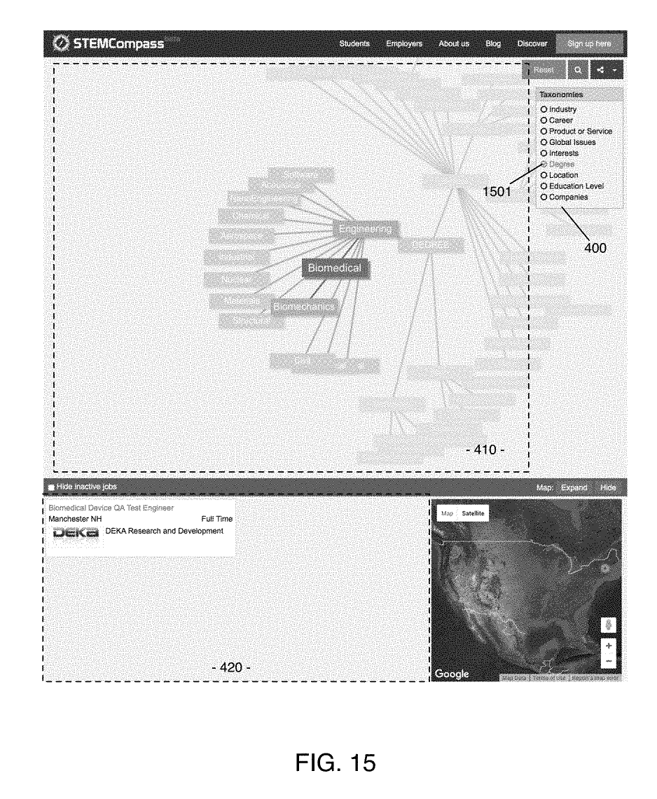

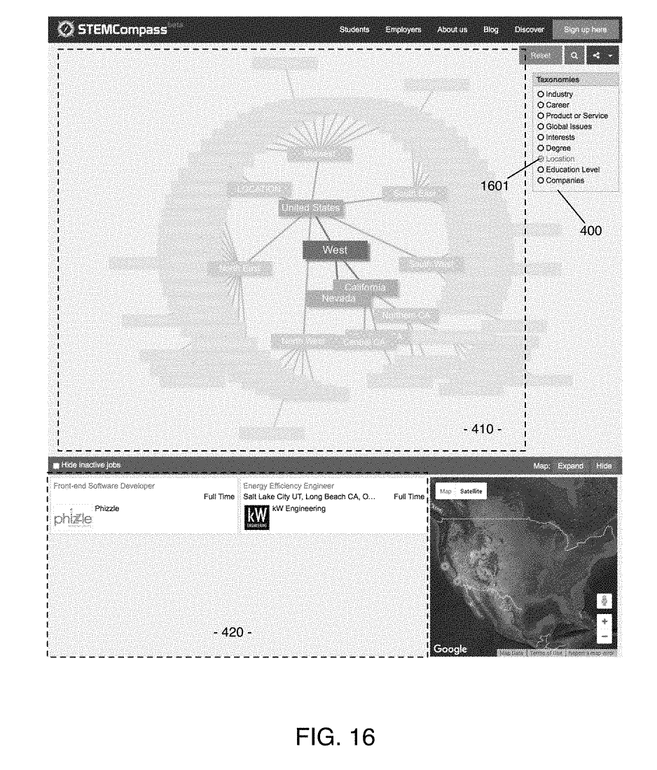

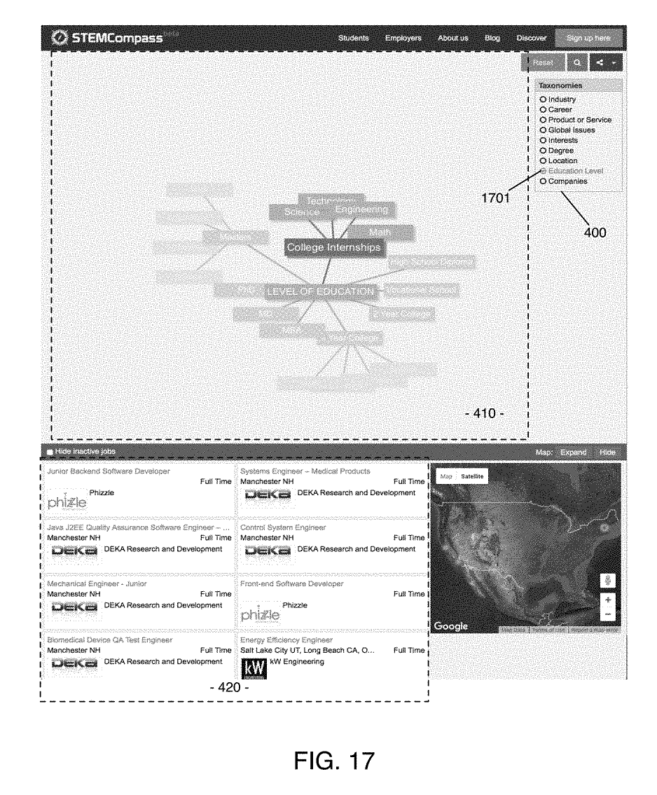

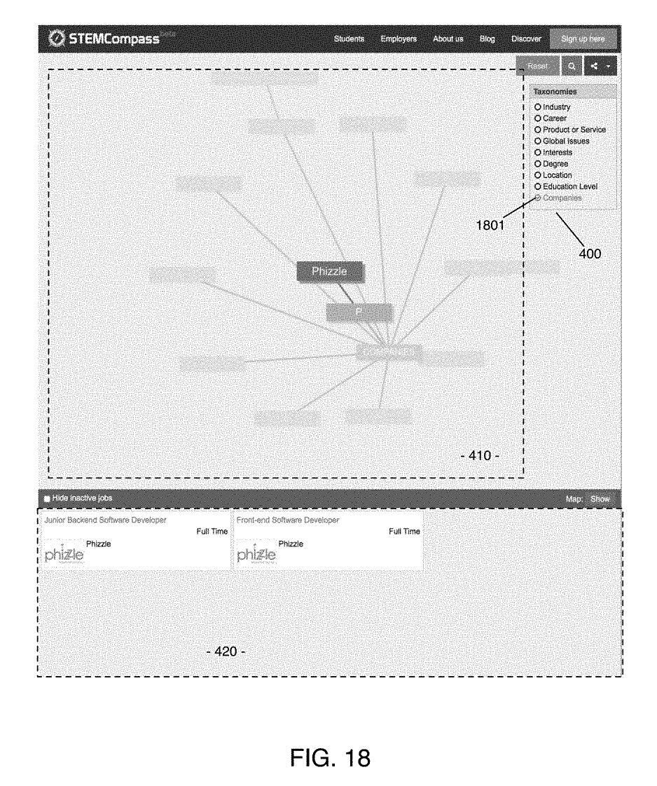

Similarly, FIG. 12 illustrates a user interface view after a “Product or Service” taxonomy is selected in region 400, via selection of radio button 1201, and node 1210 is selected, with remaining taxonomy category nodes arranged therearound. Color and other stylization are applied to node indicia within region 420 based on node distance from selected node 1210. FIGS. 13, 14, 15, 16, 17 and 18 illustrate views after taxonomies 1301 (“Global Issues”), 1401 (“Interests”), 1501 (“Degree”), 1601 (“Location”), 1701 (“Education Level”) and 1801 (“Companies”), respectively, are selected within region 400. Various views of nodes within the selected taxonomy are rendered in region 410, with associated job and career cards rendered in secondary display region 420.

By implementing systems and processes such as those described herein, even users with limited knowledge concerning a field of work may intuitively and effectively navigate job and career opportunities and identify opportunities of interest. In the embodiments of, e.g., FIGS. 5A and 7-18, a navigable, adaptive taxonomic node network is used to simultaneously convey information to a user about selected taxonomy hierarchies, while also controlling the display of job and career opportunities within a secondary display area. In effect, a node selection from within a taxonomic node network can be used to dynamically filter a set of job and career opportunities.

However, the navigable taxonomic node network described above can also be used to explore, and select items from, complex hierarchies for use cases other than automatically filtering job opportunities or otherwise controlling a secondary display area. For example, in the context of employment-related platforms, users may traditionally be required to navigate numerous picklists or checklists to identify skills, degrees, interests, industries and other types of information. Such lists may be extremely lengthy, difficult to navigate and have unintuitive ordering. Alternatively, the node network mechanisms described above can be navigated for purposes of discovering and selecting network elements. Elements selected from a dynamic node network can then be used for tasks such as building complex, form-based, multi-criteria search queries, or filling out forms.

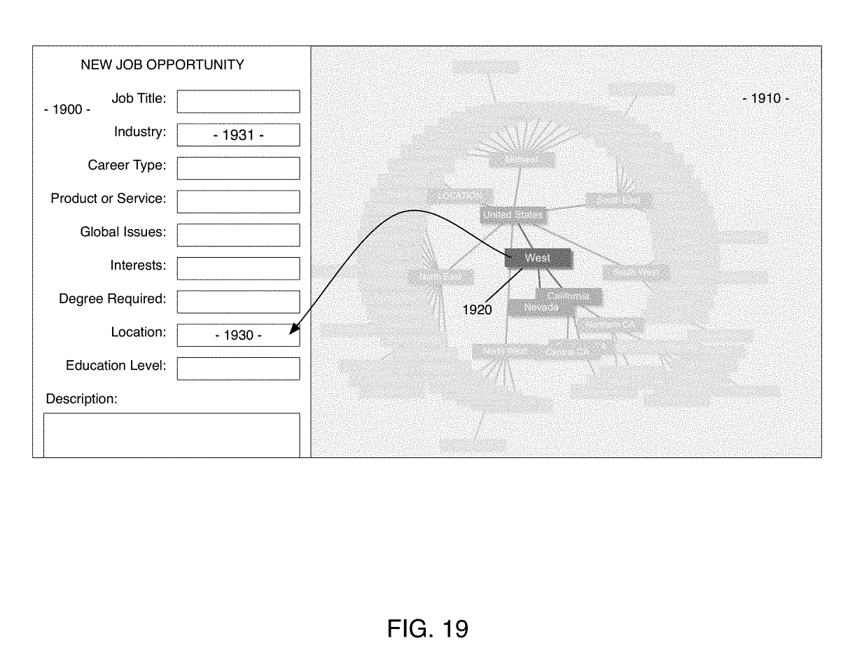

FIG. 19 illustrates an embodiment utilizing a dynamic node network visualization, such as that described above, to identify and select predetermined content items for population in a form used to configure a new job or career opportunity for population into database 104, and possible display in secondary display region 420 as described above. The embodiment of FIG. 19 is implemented within the computing environment of FIG. 1, and may be implemented as a part of admin portal 210 or employer portal 220.

Display region 1900 contains form fields, e.g. associated with configuring a new job or career opportunity. Display region 1910 contains a dynamic node network visualization, analogous to those described above in connection with FIGS. 4-18. The node network contained within region 1910 may be determined by, e.g., the form field that is currently active within region 1900. For example, when a user clicks into the Location form field 1930, the Location node network is automatically displayed in region 1910. (Likewise, if a user clicks into Industry form field 1931, a node network visualization of an Industry taxonomy can be automatically displayed in region 1910.) A selection commit action can then be applied to any of node network elements 1920 to populate information associated with the committed element into form field 1930. Examples of selection commit actions that may be employed in various user-interface embodiments include double-clicking (e.g. in a pointer-based user interface), double tapping or long-pressing (in touch-based user interfaces), or dragging-and-dropping a node indicium from region 1910 onto a target form field in region 1900. In some embodiments, multi-select actions may be available whereby, for example, multiple nodes within node display region 1910 may be selected (e.g. by shift-clicking multiple nodes in a mouse-and-keyboard based client) and dragged onto one or more form fields within form region 1900, to populate the fields with information associated with the multiple selected nodes. In this way, embodiments of the selection mechanism may accommodate relationships between taxonomic nodes and target areas on a particular job or other form, which may be one-to-one, one-to-many, many-to-one, or many-to-many, as desired for a particular application.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the invention or any appended claims.

1. A computer-implemented method for user-driven dynamic filtering of a set of career and job opportunities with a user computing device, the method comprising:
rendering a taxonomy selection mechanism on a first portion of a user computing device display screen, the taxonomy selection mechanism enabling user selection of one of a plurality of available taxonomies;
receiving a user selection of a selected taxonomy via the taxonomy selection mechanism;
displaying a taxonomic node network on a second portion of the user computing device display screen, the taxonomic node network comprising a plurality of user-selectable elements corresponding to categories within the selected taxonomy, the plurality of user-selectable elements animated for distribution around a user-selected one of said elements; and
automatically updating a third portion of the user computing device display screen to contain indicia associated with career and job opportunities categorized within a taxonomy category associated with the selected element from the taxonomic node network.

2. The computer-implemented method of claim 1, in which the taxonomy selection component comprises a plurality of radio buttons.

3. The computer-implemented method of claim 1, in which the taxonomy selection component comprises a modal taxonomy display.

4. The computer-implemented method of claim 1, in which the step of displaying a taxonomic node network comprises the step of applying stylization to the plurality of elements based on the node distance of each element from the selected element.

5. The computer-implement method of claim 4, in which the step of applying stylization to the plurality of elements comprises applying one or more of: variable color, variable apparent transparency, and/or variable font.

6. The computer-implemented method of claim 1, in which the plurality of available taxonomies comprises one or more of: industry, career type, product or service, global issues, interests, degree, location, education level and company.

7. The computer-implemented method of claim 1, further comprising:
receiving a user selection of a career and job opportunity indicia from the third portion of the user computing device display screen; and
displaying on the user computing device display screen detail information concerning a career and job opportunity corresponding to the selected indicia.

8. A computer-implemented method for populating information within form fields of a user interface on a computing device display screen, the method comprising:
displaying a plurality of form fields;
receiving a user selection of an active form field from amongst the plurality of form fields, the active form field configured for content from within a predetermined taxonomy;
displaying a taxonomic node network on the display screen comprising a plurality of user-selectable elements associated with the predetermined taxonomy, the plurality of user-selectable elements animated for radial distribution around a selected one of said elements;
receiving a selection commit action associated with a selected one of said taxonomic node network elements; and
populating information associated with the selected taxonomic node network element into the active form field.

9. The computer-implemented method of claim 8, in which the selection commit action comprises double-clicking.

10. The computer-implemented method of claim 8, in which the selection commit action comprises dragging-and-dropping the selected taxonomic node network element into the active form field.
